(19) United States
(12) Patent Application Publication
(10) Pub. No.: US 2026/0239060 A1
(43) Pub. Date: Aug. 13, 2026

(54) MULTI-LAYER REFERENCE SIGNALS

(71) Applicant: QUALCOMM Incorporated, San Diego, CA (US)

(72) Inventors: Chih-Hao LIU, San Diego, CA (US); Jing JIANG, San Diego, CA (US)

(21) Appl. No.: 19/049,764

(22) Filed: Feb. 10, 2025

(51) Int. Cl. H04W 24/10; H04L 5/00

(52) U.S. Cl. CPC H04W 24/10; H04L 5/0048

(57) ABSTRACT

A method for wireless communication at a user equipment (UE) and related apparatus are provided. In the method, the UE transmits or receives a set of reference signals (RS) in a first modulation order. The first modulation order is equivalent to a second modulation order of a scheduled physical downlink shared channel (PDSCH) or physical uplink shared channel (PUSCH) on the UE, and the set of RS corresponds to a first number of signal streams. The first number of signal streams is less than or equal to a second number of data layers between the UE and a network entity. The UE further obtains a measurement result based on the set of RS, and communicates with the network entity via the set of RS based on the measurement result.

### TECHNICAL FIELD

The present disclosure relates generally to communication systems and, more particularly, to the configuration of reference signals in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to transmit or receive a set of reference signals (RS) in a first modulation order. The first modulation order is equivalent to a second modulation order of a scheduled physical downlink shared channel (PDSCH) or physical uplink shared channel (PUSCH) on the UE, and the set of RS corresponds to a first number of signal streams. The first number of signal streams is less than or equal to a second number of data layers between the UE and a network entity. The at least one processor may be further configured to obtain a measurement result based on the set of RS and communicate with the network entity via the set of RS based on the measurement result.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to transmit or receive a set of RS in a first modulation order. The first modulation order is equivalent to a second modulation order of a scheduled PDSCH or PUSCH with a UE, and the set of RS may correspond to a first number of signal streams. The first number of signal streams is less than or equals to a second number of data layers between the UE and the network entity. The at least one processor may be further configured to obtain a measurement result based on the set of RS and communicate with the UE via the set of RS based on the measurement result.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of the demodulation reference signal (DMRS).

FIG. 5 is a diagram illustrating the examples of noise covariance matrix estimation reference signals.

FIG. 6 is a diagram illustrating an example of the phase jump and reference signals used for the phase estimate in a phase jump boundary.

FIG. 7A is a diagram illustrating an example of cross-layer interference in multi-user multiple input multiple output (MU-MIMO) wireless communication.

FIG. 7B is a diagram illustrating the examples of reference signals configured for different UEs.

FIG. 8A is a diagram illustrating an example of the reference signal generation based on one binary sequence in accordance with various aspects of the present disclosure.

FIG. 8B is a diagram 850 illustrating an example of the reference signal generation based on multiple binary sequences in accordance with various aspects of the present disclosure

FIG. 9 is a diagram illustrating the examples glue reference signals in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a network entity in accordance with various aspects of the present disclosure.

FIG. 14 is a flowchart illustrating methods of wireless communication at a network entity in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

In multi-user multiple input multiple output (MU-MIMO) wireless communication, when cross-layer interference from another receiver is present, a target receiver may apply a spatial filter, such as a minimum mean square error (MMSE) spatial filter, to mitigate the cross-layer interference before decoding a received signal. In some examples, the target receiver may perform blind modulation order detection (BMOD) for a set of layers associated with the cross-layer interference. If the detected modulation order matches that of the layers associated with the target receiver, the receiver may proceed with joint decoding by successively canceling out the detected interference from the set of layers. However, when reference signals (RS), such as noise covariance matrix estimation RS (Rnn RS), glue RS, or phase tracking reference signal (PTRS), are configured on a per-link basis, the modulation order at those RS resource elements (REs) may be different from the scheduled modulation for the target receiver. In such cases, joint decoding and successive interference cancellation become ineffective. Example aspects presented herein provide multi-layer quadrature amplitude modulation (QAM) for reference signals that can be configured for specific scenarios, such as per link, per cell, or at the multi-cell (network-wide) levels. In some examples, for a joint MU-MIMO decoder, the RS may be transmitted using the same modulation order as the data channel (e.g., downlink or uplink). In some examples, glue RS is provided to improve channel estimation across phase jump boundaries.

Various aspects relate generally to wireless communication. Some aspects more specifically relate to the configuration of reference signals in wireless communication. In some examples, a UE may transmit or receive a set of reference signals (RS) in a first modulation order. The first modulation order may be equivalent to a second modulation order of a scheduled physical downlink shared channel (PDSCH) or physical uplink shared channel (PUSCH) on the UE. The set of RS may correspond to a first number of signal streams, and the first number of signal streams may be less than or equal to a second number of data layers between the UE and a network entity. The UE may further obtain a measurement result based on the set of RS and communicate with the network entity via the set of RS based on the measurement result. In some aspects, the first modulation order may be a first quadrature amplitude modulation (QAM) modulation order, and the second modulation order may be a second QAM modulation order. In some aspects, the set of RS may include a first set of noise covariance reference signals, a second set of glue reference signals, or a third set of phase tracking reference signals (PTRS), and the set of RS may be based on the modulation of one or more binary sequences into QAM modulation symbols. In some examples, the UE may generate a seed sequence and generate the second number of data layers of the RS QAM symbols based on the seed sequence, and the second number of data layers of the RS QAM symbols may include the repetition of an RS QAM symbol for the second number of data layers. In some examples, the UE may generate a first number of seed sequences and generate the second number of data layers of the RS QAM symbols respectively based on the first number of seed sequences, and each of the second number of data layers of the RS QAM symbols may be independent from each other.

Particular aspects of the subject matter described in this disclosure can be implemented to realize one or more of the following potential advantages. In some examples, by providing reference signals (e.g., noise covariance RS or Rnn RS) in certain time domain resources (e.g., those without demodulation reference signal (DMRS) symbols), and ensuring that the RS is transmitted using the same modulation order as the scheduled downlink or uplink transmissions, the described techniques enable a receiver to more effectively capture and compensate for interference, including interference from thermal noise and cross-cell interference, thereby improving signal stability and reducing decoding errors in wireless communication. In some examples, by providing RS (e.g., glue RS) near phase jump boundaries and mapping these RS to corresponding data layers, the described techniques facilitate accurate phase correction even when DMRS is not available, thereby ensuring the reliability of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

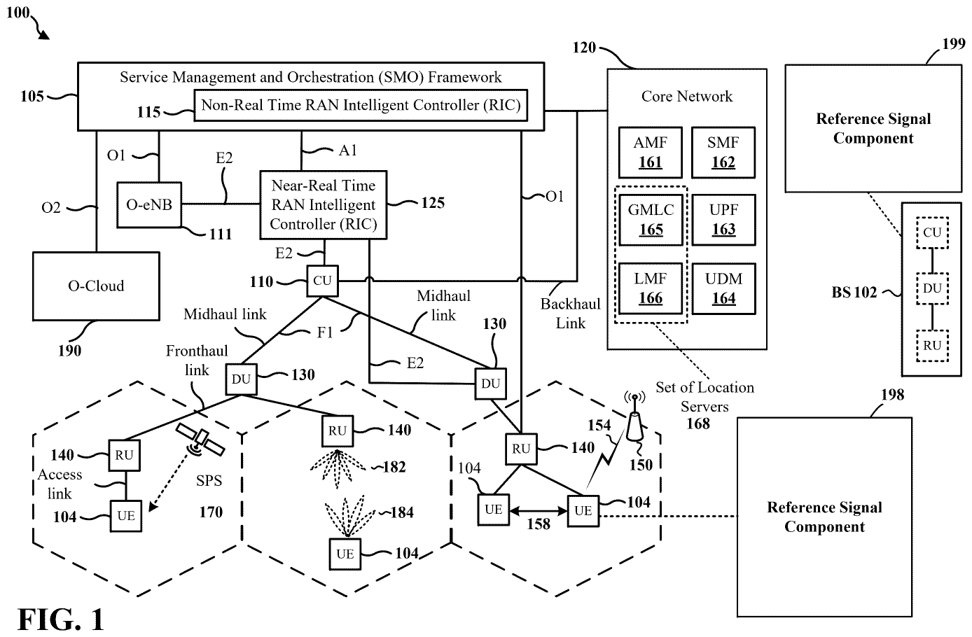

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the reference signal component 198. The reference signal component 198 may be configured to transmit or receive a set of RS in a first modulation order, where the first modulation order is equivalent to a second modulation order of a scheduled PDSCH or PUSCH on the UE, where the set of RS corresponds to a first number of signal streams, and where the first number of signal streams is less than or equal to a second number of data layers between the UE and a network entity; obtain a measurement result based on the set of RS; and communicate with the network entity via the set of RS based on the measurement result. In certain aspects, the base station 102 may include the reference signal component 199. The reference signal component 199 may be configured to transmit or receive a set of RS in a first modulation order, where the first modulation order is equivalent to a second modulation order of a scheduled PDSCH or PUSCH with a UE, where the set of RS corresponds to a first number of signal streams, and where the first number of signal streams is less than or equals to a second number of data layers between the UE and the network entity; obtain a measurement result based on the set of RS; and communicate with the UE via the set of RS based on the measurement result. Although the following description may be focused on 5G NR, the concepts described herein may be applicable to other similar areas, such as LTE, LTE-A, CDMA, GSM, and other wireless technologies.

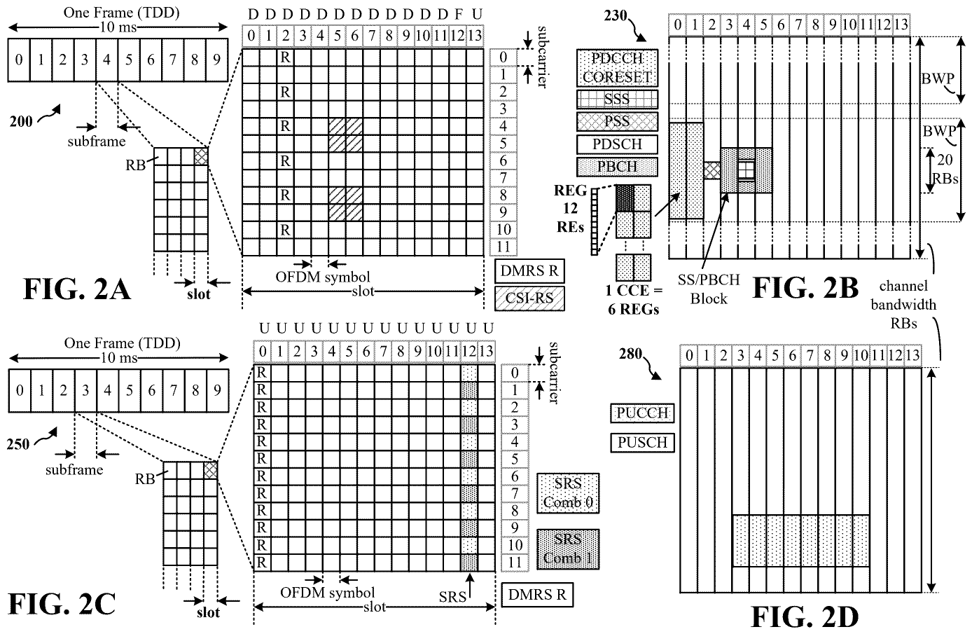

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[KHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

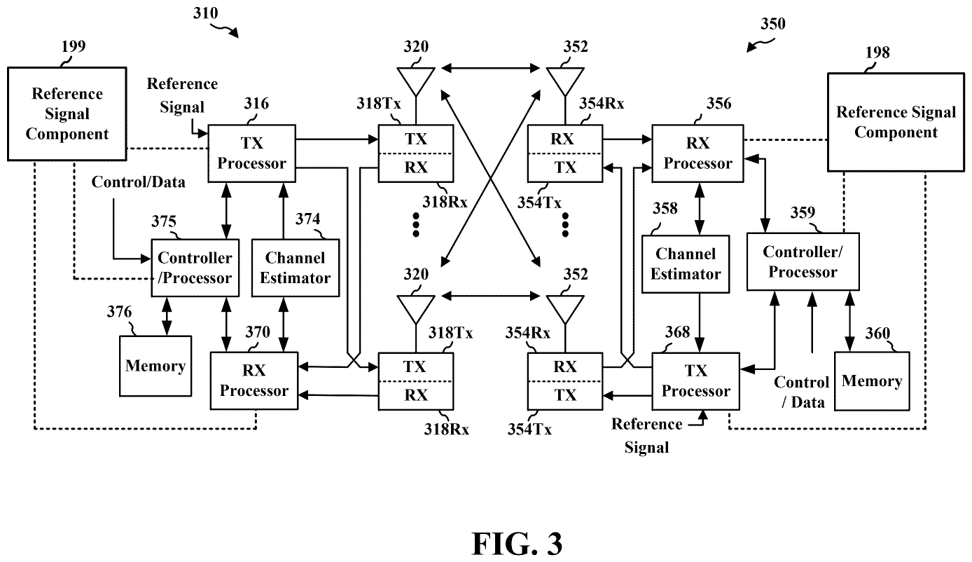

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reference signal component 198 of FIG. 1.

At least one of the TX processor 316, the RX processor 370, and the controller/processor 375 may be configured to perform aspects in connection with the reference signal component 199 of FIG. 1.

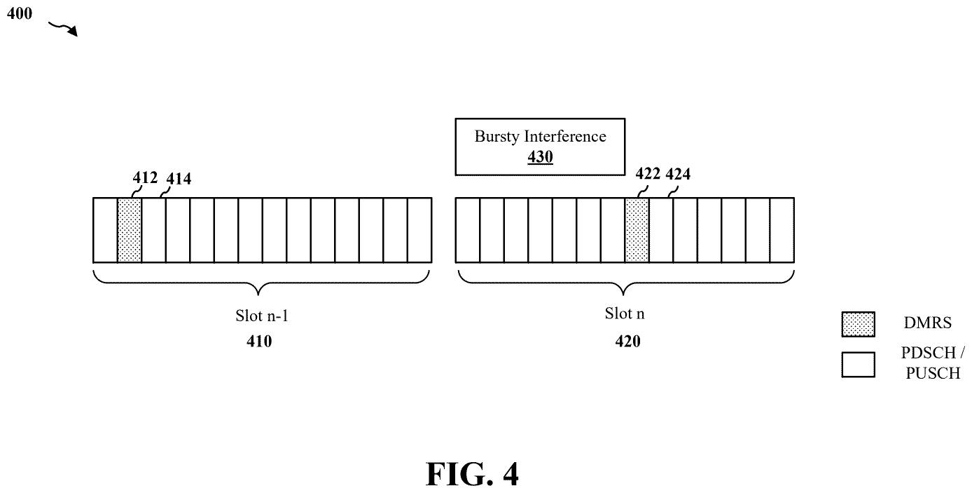

A reference signal (RS) is a predefined signal transmitted by a base station (e.g., gNB) or user equipment (UE) to support various functions in wireless communication. For example, a phase tracking reference signal (PTRS) may be used to compensate for phase noise and frequency errors, and a demodulation reference signal (DMRS) may be used for channel estimation and equalization. FIG. 4 is a diagram 400 illustrating an example of the DMRS. As shown in FIG. 4, DMRS may be provided in one or more symbols in a slot (e.g., symbol 412 in slot 410 or symbol 422 in slot 420). The symbols that include DMRS (e.g., symbols 412, 422) may be referred to as “DMRS symbols,” which may be used for tasks such as interference measurements (e.g., measurements of bursty interference 430). In some examples, the symbols in the slots that do not include DMRS (e.g., symbols 414, 424) may be used for downlink or uplink transmission, such as physical downlink shared channel (PDSCH) or physical uplink shared channel PUSCH transmission.

In some examples, reference signals may be used to estimate the noise covariance matrix between the transmitter and receiver, which may be referred to as the noise covariance matrix estimation RS, Rnn estimation RS, or Rnn RS. The noise may include thermal noise and interference-induced noise.

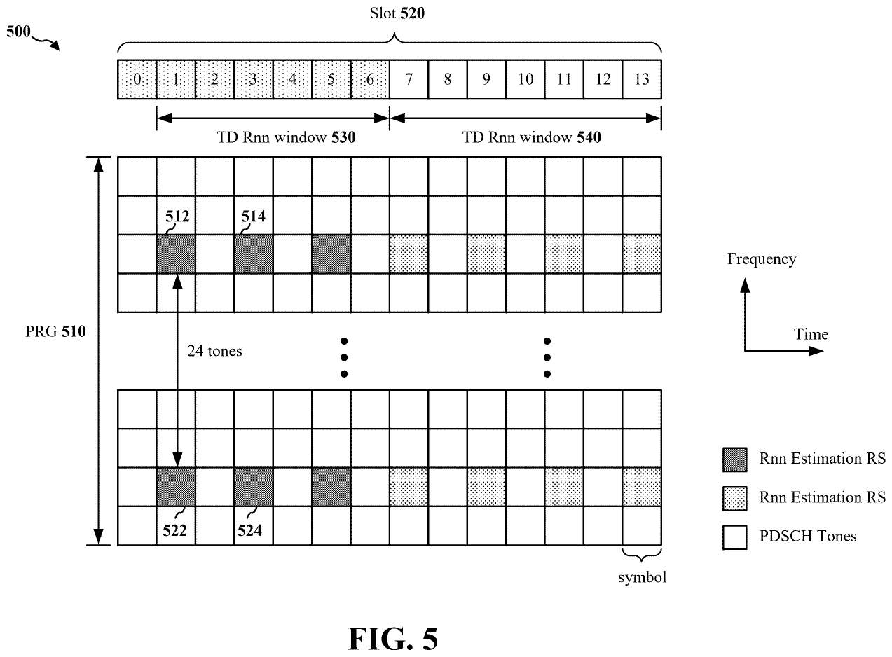

In some examples, the Rnn RS may have a low density in the time domain and may be provided where DMRS symbols are absent to facilitate the receiver to measure the interference more effectively. In some examples, the configuration of Rnn RS resources may be based on PTRS and may be applied to multiple data layers. FIG. 5 is a diagram 500 illustrating the examples of noise covariance matrix estimation reference signals. For example, as shown in FIG. 5, in the frequency domain (FD), Rnn RS may be allocated per physical resource group (PRG), such as PRG 510, and in the time domain (TD), Rnn RS may be configured per slot (e.g., slot 520) on non-DMRS symbols (e.g., symbols that do not include DMRS) or based on a TD Rnn averaging window (e.g., TD Rnn window 530, 540), which is determined by the time-domain interference pattern. The DMRS symbols may be configured with specific intervals in the time domain and the frequency domain. For example, in the example in FIG. 5, adjacent DMRS symbols (e.g., DMRS symbols 512 and 514, or DMRS symbols 522 and 524) may be spaced by two symbols in the time domain. In the frequency domain, the DMRS tones may be arranged with a fixed interval (e.g., 24 tones).

Different configuration options for Rnn RS may be used to adapt to varying interference conditions. In some examples, Rnn RS may be configured on a per-link basis. In that case, a base station may configure an Rnn RS pattern for each link based on the interference pattern observed at the receiver. In some examples, Rnn RS may be configured on a per-cell basis. In that case, the base station may configure the Rnn RS pattern at a cell-wide level for its UE to mitigate neighboring cell's interference. In some examples, Rnn RS may be configured on at the network level (e.g., on a per-network basis). The quality of Rnn estimation for a given RS tone may be affected by the modulation order of the interference. For examples, a given RS tone may provide more accurate estimation on lower modulation order quadrature amplitude modulation (QAM) interference than on higher-order QAM interference. In some examples, Rnn RS tones across a group of neighboring cells may be aligned to further enhance estimation performance.

In some examples, for multi-layer PDSCH transmission, the Rnn RS may maintain the spatial characteristics of the PDSCH. As a result, if the interference cell's Rnn estimation RS collides with the Rnn estimation RS in the target cell, the target UE may still estimate the interference with rank greater than one from the interference cell. For the Rnn RS that is configured at the network level (e.g., on a per-network basis) and the Rnn RS locations are aligned, the neighboring cell's Rnn RS may collide with the target cell's Rnn RS. As used herein, each “layer” represents an independent data stream transmitted over the frequency-time resources, and “multi-layer PDSCH transmission” refers to PDSCH transmission where PDSCH data is spited into multiple layers and transmitted simultaneously over the same frequency-time resources.

In some examples, for multi-layer PDSCH transmission, the Rnn estimation RS may have the same number of layers and the same precoder as in the PDSCH. For example, for an L-layer PDSCH transmission, where L represents the number of layers, L-layer Rnn estimation RS may be configured and mapped to L ports of the PDSCH. The different layers of Rnn estimation RS may be uncorrelated and may be generated either from different random generators or from the same random generator with different initial seeds. In some examples, the same PDSCH precoder may be applied to the multi-layer Rnn estimation RS transmission.

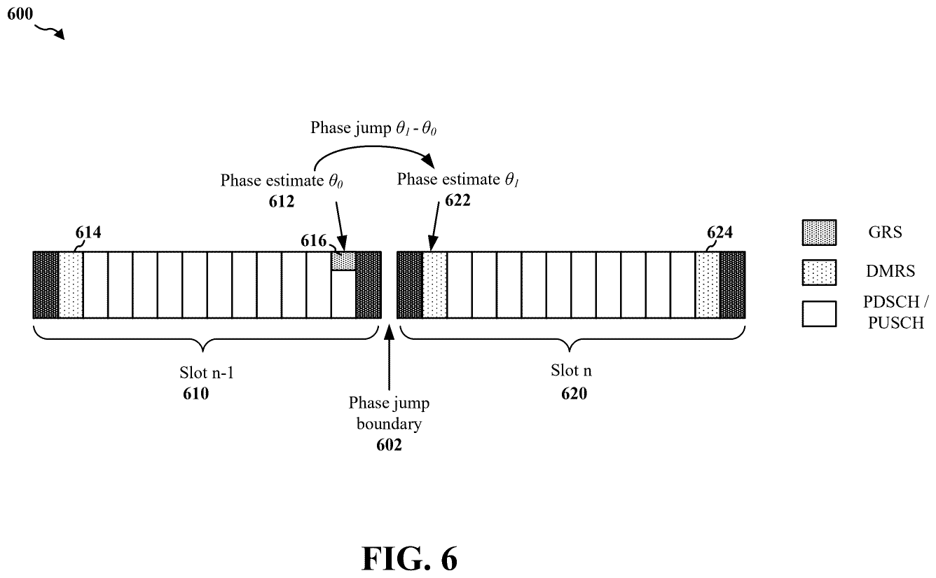

In some examples, a sudden change in the phase of a signal may occur across the boundaries of time-domain resources (e.g., across boundaries of slots), referred to as a phase jump. FIG. 6 is a diagram 600 illustrating an example of the phase jump and reference signals used for the phase estimate in a phase jump boundary. As shown in FIG. 6, a sudden change in the phase (e.g., θ) of a signal from θ₀ 612 at slot 610 to θ₁ 622 at slot 620 may occur across the phase jump boundary 602 between boundaries of slots 610 and 620.

These phase discontinuities (e.g., from θ₀ 612 to θ₁ 622) at the boundaries can degrade signal quality. Accurately measuring or estimating the phase jump can help compensate for these phase discontinuities and maintain reliable wireless communication. In some examples, the phase jump estimation may be integrated into the channel estimation process. For example, when DMRS symbols are present on both sides of the boundary (e.g., spanning both slots 610 and 620, where the phase jump occurs), these DMRS may be used to measure the phase jump. However, if DMRS are located far from the boundary, on one side or both sides, the phase jump measured using DMRS may be indistinguishable from phase changes caused by the Doppler effect. For example, in the example in FIG. 6, the DMRS symbols 614, 624 are located far from the phase jump boundary 602, and may not be used to accurately measure the phase jump (e.g., the phase jump from θ₀ 612 at slot 610 to θ₁ 622 at slot 620).

In some aspects, a glue reference signal, or gRS, may be provided around the phase jump boundary to estimate the phase jump. For example, in FIG. 6, a glue RS 616 may be provided around the phase jump boundary 602 to estimate the phase jump. In some examples, the glue RS (e.g., glue RS 616) may be a cyclic prefix orthogonal frequency division multiplexing (CP-OFDM) glue RS. The functionality of the glue RS may be similar to that of the PTRS and may use a similar frequency domain density design as PTRS. In some examples, in the frequency domain, the glue RS (e.g., glue RS 616) may occupy one resource element (RE) every few resource blocks (RBs) (e.g., every 2 or 4 RBs) and puncture the resources allocated for physical uplink shared channel (PUSCH) or PDSCH transmissions. In the time domain, glue RS (e.g., glue RS 616) symbols may be positioned as close to the phase jump boundary (e.g., boundary of slot 610) as possible, e.g., in cases where no DMRS symbols are available for reuse for phase jump estimation.

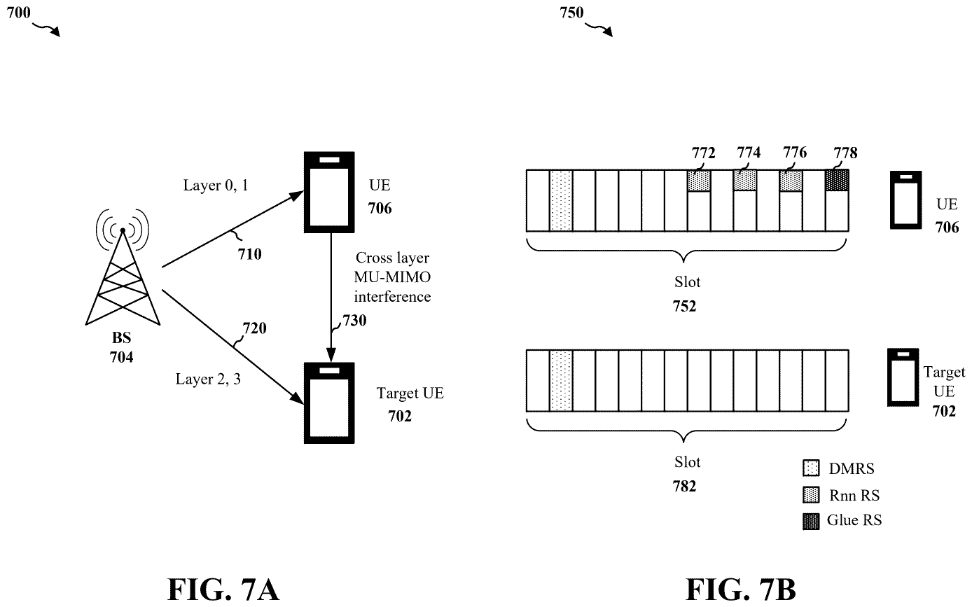

In multi-user multiple input multiple output (MU-MIMO) wireless communication, cross-layer interference presents a challenge for the target receiver (e.g., a target UE). FIG. 7A is a diagram 700 illustrating an example of cross-layer interference in MU-MIMO wireless communication. As shown in FIG. 7A, in MU-MIMO, a base station 704 may simultaneously communicate with multiple UEs, such as UE 702 and UE 706. As an example, the base station 704 may communicate with UE 706 via layer 0 and 1 at 710, and communicate with UE 702 via layer 2 and 3 at 720. The communication between base station 704 and UE 706 may cause cross-layer interference (e.g., at 730) to the communication between base station 704 and UE 702. In the example of FIG. 7A, UE 702 is the UE that was affected by the interference and may also be referred to as an interfered UE or target UE (or target receiver). UE 706 is the UE that causes the interferences and may also be referred to as an interfering UE.

To mitigate this interference, the target receiver (e.g., UE 702) may apply a spatial filter, such as a minimum mean square error (MMSE) spatial filter, to null out the interference from another receiver (e.g., interfering UE 706) before decoding a received signal (e.g., a signal received via 720). In some examples, the target receiver (e.g., UE 702) may perform blind modulation order detection (BMOD) for a set of layers (e.g., layer 0 and layer 1 at 710) associated with the cross-layer interference. If the detected modulation order matches that of the layers associated with the target receiver (e.g., UE 702), such as layer 2 and layer 3 at 720, the receiver (e.g., UE 702) may proceed with joint decoding by successively canceling out the detected interference from the set of layers (e.g., layer 0 and layer 1 at 710).

However, when reference signals, such as Rnn RS, glue RS, or PTRS, are configured on a per-link basis (e.g., configured in the link to UE 706), the modulation order at those RS REs may be quadrature phase shift keying (QPSK) and may be different from the scheduled modulation for the target UE (e.g., UE 702). In such cases, joint decoding and successive interference cancellation become ineffective. FIG. 7B is a diagram 750 illustrating the examples of reference signals configured for different UEs. As shown in FIG. 7B, reference signals, such as Rnn RS (e.g., 772, 774, 776 in slot 752) and glue RS (e.g., 778 in slot 752), may be configured on a per-link basis for UE 706. The modulation order for these RS REs may be different from the scheduled modulation for the target UE (e.g., the modulation associated with slot 782 for UE 702). As a result, joint decoding and successive interference cancellation become ineffective for UE 702.

Example aspects presented herein provide methods and apparatus for multi-layer quadrature amplitude modulation (QAM) for reference signals that can be configured for specific scenarios, such as per link, per cell, or at the multi-cell (network-wide) levels. In some example aspects, for a joint MU-MIMO decoder, the RS may be transmitted using the same modulation order as the data channel (e.g., downlink or uplink). Some example aspects include methods for generating an Rnn estimation RS that may be flexibly configured at the per-link, per-cell, or multi-cell (network-wide) level. Some example aspects provide glue RS for channel estimation improvement across phase jump boundaries.

In some aspects, for a joint MU-MIMO decoder to function effectively, the reference signal may be transmitted using the same modulation order as the PDSCH or PUSCH. For example, the Rnn RS, glue RS, or PTRS may be transmitted in the same modulation order as the scheduled PDSCH or PUSCH. In some examples, the QAM modulation order of the reference signals, including Rnn RS, glue RS, or PTRS, may be identical to the modulation order of the PDSCH or PUSCH.

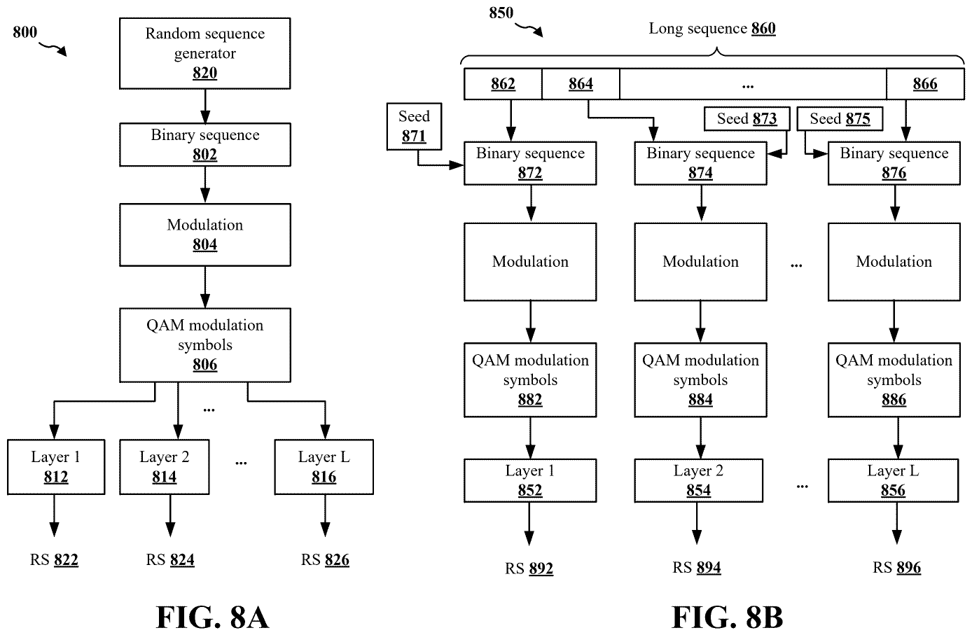

In some aspects, the reference signal may be formed by modulating a binary sequence into QAM modulation symbols. FIG. 8A is a diagram 800 illustrating an example of the reference signal generation based on one binary sequence in accordance with various aspects of the present disclosure. As shown in FIG. 8A, a reference signal may be formed by modulating a binary sequence 802 into QAM modulation symbols 806 via a modulation process 804.

As an example, the binary sequence (e.g., binary sequence 802) may be generated using a random sequence generation method (e.g., via the random sequence generator 820), and may be subsequently mapped into QAM modulation symbols (e.g., QAM modulation symbols 806). In some examples, if an orthogonal coverage code (OCC) is applicable, such as in the case of glue RS, the OCC may be applied on top of the QAM reference signal.

In some aspects, a multi-layer Rnn RS may have multiple (e.g., L, L>1) independent streams (or layers) of Rnn RS, and the Rnn Rs may be transmitted in these multiple (e.g., L) data layers with the same precoding. For example, as shown in FIG. 8A, the multiple data layers may include layer 1 812, layer 2 814, through layer L 816. In some examples, for a glue RS in a downlink transmission or within a port coherence group in the uplink transmission, the glue RS may be transmitted in a virtual port, meaning it is transmitted in all active DMRS ports within each DMRS code division multiplexing (CDM) group. In some examples, the reference signal may be repeated across all active DMRS ports within each DMRS CDM group in a given link.

In some examples, for each glue RS tone, the number of layers may be identical to the number of active DMRS per CDM group, although the number of layers may not match the number of layers in the PDSCH or PUSCH. In some aspects, the original glue RS may be configured to match the DMRS, and different DMRS ports may be frequency division multiplexed (FDMed).

In some aspects, for glue RS, multiple (e.g., L) independent streams or repeated streams of RS be mapped to multiple (e.g., L) data layers. For example, each glue RS resource element (RE) may carry multiple (e.g., L) layers of RS QAM symbols if multiple (e.g., L) layers of PDSCH or PUSCH have been scheduled.

In some aspects, the multiple (e.g., L) layers of reference signals (e.g., gRS) may be derived from different approaches. In one configuration, the multiple (e.g., L) layers of reference signals (e.g., gRS) may be derived from the repetition of an RS QAM symbol across the multiple (e.g., L) layers. In some examples, a single random sequence generation may be used to generate the multiple layers of reference signals (e.g., gRS), and the modulated QAM RS may be repeated in all layers (e.g., all L layers). For example, as shown in FIG. 8A, L layers of reference signals (e.g., reference signal 822, 824, 826) may be derived from the repetition of an RS QAM symbol (e.g., QAM modulation symbols 806) across the L layers (e.g., layer 1 812, layer 2 814, through layer L 816). In some examples, a single random sequence generation (e.g., random sequence generator 820) may be used to generate the multiple layers of reference signals (e.g., reference signal 822, 824, 826), and the modulated QAM RS may be repeated in all layers (e.g., layer 1 812, layer 2 814, through layer L 816).

In another configuration, the multiple (e.g., L) layers of reference signals may be derived based on multiple (e.g., L) independent streams of QAM RS. In this case, multiple (e.g., L) independent random sequences may be generated, respectively corresponding to the multiple layers of reference signals (e.g., gRS). FIG. 8B is a diagram 850 illustrating an example of the reference signal generation based on multiple binary sequences in accordance with various aspects of the present disclosure. As shown in FIG. 8B, L layers of reference signals (e.g., reference signals 892, 894 through 896) may be derived based on L independent streams of QAM RS (e.g., QAM modulation symbols 882, 884 through 886), L independent random sequences (e.g., binary sequences 872, 874 through 876) may be generated, respectively corresponding to the multiple layers of reference signals (e.g., reference signals 892, 894 through 896).

These independent random sequences may be generated in different ways. In some examples, these multiple (e.g., L) independent random sequences may be generated with a layer-dependent seed respectively corresponding for each layer. For example, the layer-dependent seeds may include seed 871 for layer 1 852, seed 873 for layer 2 854, and seed 875 for layer L 856. These seeds (seed 871, seed 873, and seed 875) may be independent from each other.

In some examples, these multiple (e.g., L) independent random sequences may be generated using one long random sequence whose length is L times that of the random sequence for an individual layer, and each independent random sequence may be generated using a portion (e.g., 1/L) of the long random sequence. For example, as shown in FIG. 8B, L independent random sequences (e.g., binary sequences 872, 874 through 876) may be generated using a long random sequence 860, whose length may be at least L times that of the random sequence for an individual layer (e.g., binary sequence 872). The random sequence for layer 1 (e.g., binary sequence 872) may be generated using a portion (e.g., 862) of the long random sequence 860. Similarly, the random sequence for layer 2 (e.g., binary sequence 874) may be generated using a second portion (e.g., 864) of the long random sequence 860, and the random sequence for layer L (e.g., binary sequence 876) may be generated using a third portion (e.g., 866) of the long random sequence 860. In some examples, the multiple (e.g., L) independent random sequences may be mapped to multiple (e.g., L) QAM RSs accordingly. For example, binary sequence 872 may be mapped to QAM modulation symbols 882, and binary sequence 874 may be mapped to QAM modulation symbols 884.

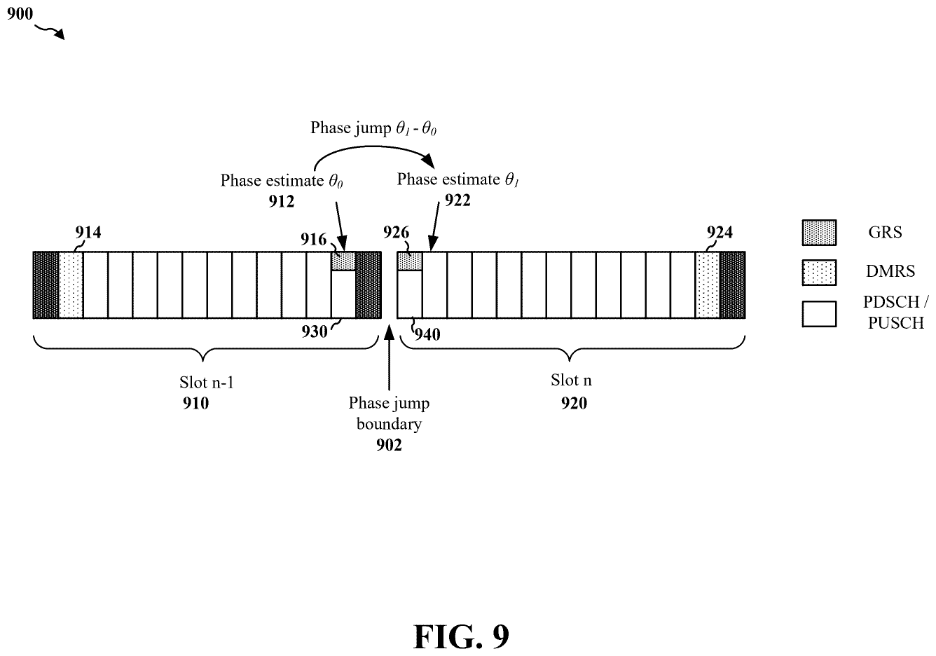

In some aspects, glue RS may be provided (e.g., in the boundary symbols of a slot) to facilitate DMRS combining across the phase jump gap and enable joint channel estimation. FIG. 9 is a diagram 900 illustrating the examples glue reference signals in accordance with various aspects of the present disclosure. As shown in FIG. 9, a sudden change in the phase (e.g., θ) of a signal from θ₀ 912 at slot 910 to θ₁ 922 at slot 920 may occur across the phase jump boundary 902 between boundaries of slots 910 and 920. In FIG. 9, glue RS (e.g., 916, 926) are provided in boundary symbols (e.g., symbol 930 in slot 910 or symbol 940 in slot 920) to facilitate DMRS (e.g., DMRS at symbols 914, 924) combining across the phase jump gap (e.g., phase jump boundary 902) and enable joint channel estimation.

Since channel estimation in the last few symbols of a slot may not be available or accurate in scenarios affected by Doppler effects, joint phase and channel estimation may be performed by leveraging DMRS across the phase jump gap. In some PTRS implementations, channel estimation may be available within PTRS symbols, so that the receiver may estimate phase noise from multi-port DMRS to a single-port PTRS. For example, suppose xᵢ represents the reference signal for the i^{th} layer, and hi represents the frequency channel response at the RS tone for the i^{th} layer, when the multiple (e.g., L) layers of reference signals are derived based on the repetition of an RS QAM symbol across the multiple (e.g., L) layers, the reference signal (e.g., reference signal 822, 824, 826) for different layer (e.g., xᵢ) may be identical, and the reference signal xᵢ across the phase jump gap (e.g., across phase jump boundary 902) may be different and may be known. In some examples, the reference signal may vary from symbol to symbol and from slot to slot to help randomize interference.

In some examples, when the multiple (e.g., L) layers of reference signals (e.g., reference signals 822, 824, 826) are derived based on the repetition of an RS QAM symbol across the multiple (e.g., L) layers, the glue RS may be repeated in all data layers, and the glue RS may be time-dependent and may vary across the potential phase jump boundary (e.g., across phase jump boundary 902). In some examples, when xᵢ is independent across the layers (e.g., in the example in FIG. 8B), xᵢ may be maintained to be identical across the phase jump boundaries (e.g., across phase jump boundary 902) since the channel hi is unknown but is assumed to remain constant across the short phase jump gap (e.g., across phase jump boundary 902). At the receiver side, x₀ and x₁ may not be individually descrambled.

In some examples, when the multiple (e.g., L) layers of reference signals (e.g., reference signal 892, 894, 896) are derived based on multiple (e.g., L) independent streams of QAM RS, the glue RS may include multiple (e.g., L) independent streams, and the glue RS may remain the same across potential phase jump boundaries (e.g., across phase jump boundary 902).

In some aspects, although PTRS may be transmitted in one port, the PTRS transmissions may be extended to multiple (e.g., L) layers. For example, PTRS may be configured similarly as the glue RS. For example, for PTRS, multiple (e.g., L) independent streams or repeated streams of reference signals may be mapped to L data layers. Each PTRS RS resource element (RE) may carry multiple (e.g., L) layers of RS QAM symbols if multiple (e.g., L) layers of PDSCH or PUSCH have been scheduled.

In some aspects, the multiple (e.g., L) layers of PTRS may be derived from different approaches. In one configuration, the multiple (e.g., L) layers of PTRS may be derived from the repetition of an RS QAM symbol across the multiple (e.g., L) layers. In some examples, a single random sequence generation (e.g., random sequence generator 820) may be used to generate the multiple layers of PTRS, and the modulated QAM RS may be repeated in all layers (e.g., all L layers, such as layer 1 812, layer 2 814, layer L 816).

In another configuration, the multiple (e.g., L) layers of PTRS may be derived based on multiple (e.g., L) independent streams of QAM RS. In this case, multiple (e.g., L) independent random sequences may be generated, respectively corresponding to the multiple layers of PTRS. These independent random sequences may be generated in different ways. In some examples, these multiple (e.g., L) independent random sequences may be generated with a layer-dependent seed respectively corresponding for each layer. For example, as shown in FIG. 8B, L independent random sequences (e.g., binary sequences 872, 874, 876) may be generated with seed 871, 873, 875, respectively, and these seeds (e.g., seed 871, 873, 875) may be independent from each other. In some examples, these multiple (e.g., L) independent random sequences may be generated using one long random sequence whose length is L times that of the random sequence for an individual layer, and each independent random sequence may be generated using a portion (e.g., 1/L) of the long random sequence (e.g., long sequence 860). In some examples, the multiple (e.g., L) independent random sequences may be mapped to multiple (e.g., L) QAM RSs accordingly.

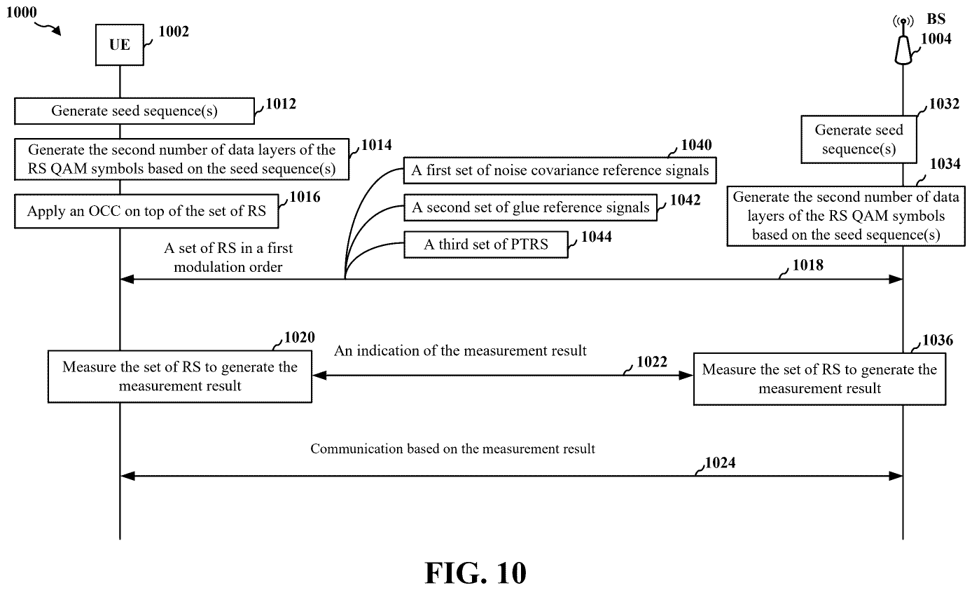

FIG. 10 is a call flow diagram 1000 illustrating a method of wireless communication in accordance with various aspects of this present disclosure. Various aspects are described in connection with a UE 1002 and a base station 1004. The aspects may be performed by the UE 1002 or the base station 1004 in aggregation and/or by one or more components of a base station 1004 (e.g., a CU 110, a DU 130, and/or an RU 140).

As shown in FIG. 10, a UE 1002 may, at 1012, generate one or more seed sequences. For example, the one or more seed sequences may be one or more binary sequences. The one or more binary sequences may correspond to one or more reference signals for one or more layers between UE 1002 and base station 1004. Referring to FIG. 8A, in some examples, the UE may generate one binary sequence 802, and the one binary sequence 802 may be used to generate the reference signals for multiple (e.g., L) layers, such as reference signal 822 for layer 1 812, reference signal 824 for layer 2 814. Referring to FIG. 8B, in some examples, the UE may generate multiple (e.g., L) binary sequences (e.g., binary sequences 872, 874, 876), which may be respectively used to generate the reference signals for multiple (e.g., L) layers, such as reference signal 892 for layer 1 852, reference signal 894 for layer 2 854, and reference signal 896 for layer L 856.

At 1014, the UE 1002 may generate the second number of data layers of the RS QAM symbols based on the seed sequence(s). For example, referring to FIG. 8A, the UE may generate the first number (e.g., L) of data layers of the RS QAM symbols (e.g., QAM modulation symbols 806) based on one seed sequence (e.g., binary sequence 802). Referring to FIG. 8B, the UE may generate the first number (e.g., L) of data layers of the RS QAM symbols (e.g., QAM modulation symbols 882, 884, 886) based on multiple seed sequences (e.g., binary sequence 872, 874, 876).

In some examples, at 1016, the UE 1002 may apply an orthogonal coverage code (OCC) on top of the set of RS. For example, the UE may apply OCC on top of reference signals 822, 824, 826.

At 1018, the base station 1004 may transmit to or receive from base station 1004 the set of reference signals in a first modulation order. The first modulation order may be equivalent to a second modulation order of a scheduled PDSCH or PUSCH on the UE 1002. In some examples, the set of RS (e.g., reference signals 822, 824, 826) may correspond to a first number of signal streams, and the first number of signal streams may be less than or equal to a second number (e.g., L) of data layers between the UE 1002 and base station 1004.

In some examples, the set of reference signals may include one of a set of noise covariance reference signals (e.g., Rnn RS) (e.g., 1040), a set of glue reference signals (e.g., 1042), or a set of PTRS (e.g., 1044). For example, the set of Rnn RS may be Rnn RS at 512, 514, 522, 524. The set of glue reference signals may include glue reference signals at 916, 926.

In some examples, the base station 1004 may generate the set of reference signals and transmit the set of reference signals to the UE 1002. For example, the base station 1004 may, at 1032, generate one or more seed sequences and, at 1034, generate the second number of data layers of the RS QAM symbols based on the one or more seed sequences.

In some examples, the UE 1002 may obtain the measurement result on the set of reference signals. In some examples, the UE 1002 may, at 1020, measure the set of RS to generate the measurement result. In some examples, the UE 1020 may, at 1022, transmit an indication of the measurement result to base station 1004.

In some examples, when the set of reference signals are received by the base station 1004, the base station 1004 may, at 1036, measure the set of RS it received to generate the measurement result. In some examples, the base station 1004 may transmit an indication of the measurement result it obtains to the UE 1002 at 1022.

In some examples, the UE 1002 and base station 1004 may communicate with each other based on the measurement result.

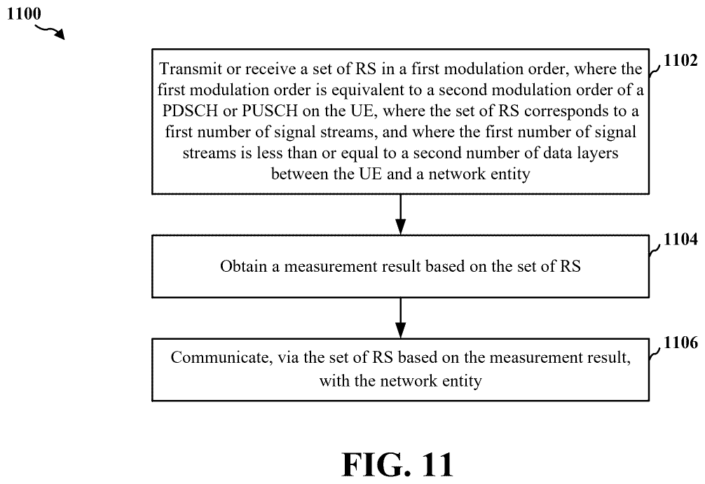

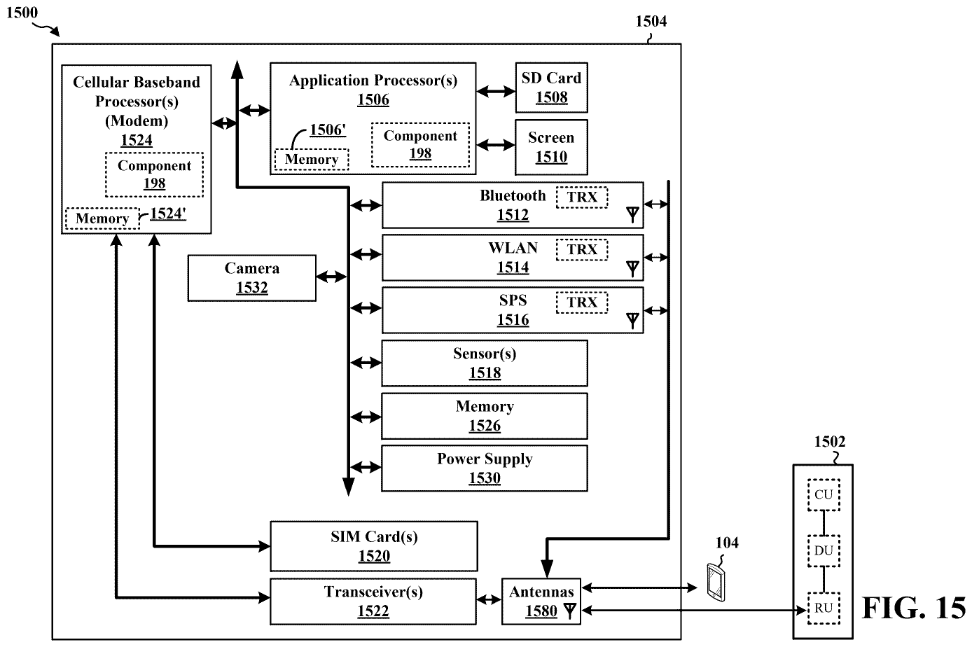

FIG. 11 is a flowchart 1100 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing reference signals (e.g., noise covariance RS or Rnn RS) in certain time domain resources (e.g., those without DMRS symbols), and ensuring that the RS is transmitted using the same modulation order as the scheduled downlink or uplink transmissions, the methods enable a receiver (e.g., UE) to more effectively capture and compensate for interference, including interference from thermal noise and cross-cell interference, thereby improving signal stability and reducing decoding errors in wireless communication. Additionally, by providing RS (e.g., glue RS) near phase jump boundaries and mapping these RS to corresponding data layers, the methods facilitate accurate phase correction even when DMRS is not available, thereby ensuring the reliability of wireless communication.

As shown in FIG. 11, at 1102, the UE may transmit or receive a set of RS in a first modulation order. The first modulation order may be equivalent to a second modulation order of a scheduled PDSCH or PUSCH on the UE. The set of RS may correspond to a first number of signal streams, and the first number of signal streams may be less than or equal to a second number of data layers between the UE and a network entity. FIG. 8A, FIG. 8B, FIG. 9, and FIG. 10 illustrate various aspects of the steps in connection with flowchart 1100. For example, referring to FIG. 10, the UE 1002 may, at 1018, transmit or receive a set of RS in a first modulation order. The first modulation order may be equivalent to a second modulation order of a scheduled PDSCH or PUSCH on the UE 1002. Referring to FIG. 8A, the set of RS (e.g., reference signals 822, 824, 826) may correspond to a first number of signal streams, and the first number of signal streams may be less than or equal to a second number (e.g., L) of data layers (e.g., layer 1 812, layer 2 814, layer L 816) between the UE 1002 and a network entity (e.g., base station 1004). In some aspects, 1102 may be performed by the signal processing component 198.

At 1104, the UE may obtain a measurement result based on the set of RS. For example, referring to FIG. 10, the UE 1002 may obtain (e.g., at 1020 or 1022) a measurement result based on the set of RS. In some aspects, 1104 may be performed by the signal processing component 198.

At 1106, the UE may communicate with the network entity via the set of RS based on the measurement result. For example, referring to FIG. 10, the UE 1002 may, at 1024, communicate with the network entity (e.g., base station 1004) via the set of RS (e.g., at 1018) based on the measurement result (e.g., at 1020). In some aspects, 1104 may be performed by the signal processing component 198.

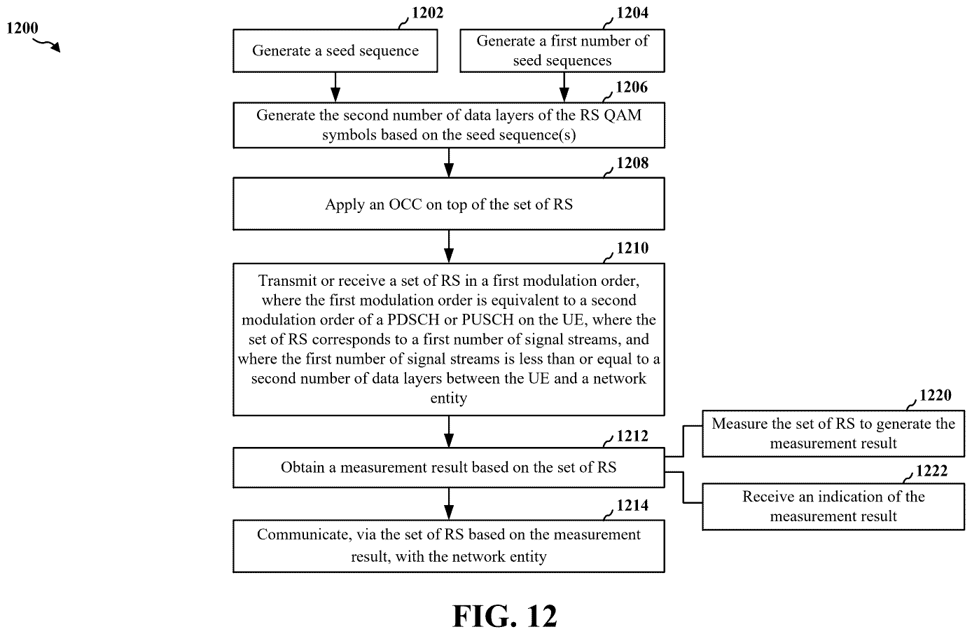

FIG. 12 is a flowchart 1200 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing reference signals (e.g., noise covariance RS or Rnn RS) in certain time domain resources (e.g., those without DMRS symbols), and ensuring that the RS is transmitted using the same modulation order as the scheduled downlink or uplink transmissions, the methods enable a receiver (e.g., UE) to more effectively capture and compensate for interference, including interference from thermal noise and cross-cell interference, thereby improving signal stability and reducing decoding errors in wireless communication. Additionally, by providing RS (e.g., glue RS) near phase jump boundaries and mapping these RS to corresponding data layers, the methods facilitate accurate phase correction even when DMRS is not available, thereby ensuring the reliability of wireless communication.

As shown in FIG. 12, at 1210, the UE may transmit or receive a set of RS in a first modulation order. The first modulation order may be equivalent to a second modulation order of a scheduled PDSCH or PUSCH on the UE. The set of RS may correspond to a first number of signal streams, and the first number of signal streams may be less than or equal to a second number of data layers between the UE and a network entity. FIG. 8A, FIG. 8B, FIG. 9, and FIG. 10 illustrate various aspects of the steps in connection with flowchart 1200. For example, referring to FIG. 10, the UE 1002 may, at 1018, transmit or receive a set of RS in a first modulation order. The first modulation order may be equivalent to a second modulation order of a scheduled PDSCH or PUSCH on the UE 1002. Referring to FIG. 8A, the set of RS (e.g., reference signals 822, 824, 826) may correspond to a first number of signal streams, and the first number of signal streams may be less than or equal to a second number (e.g., L) of data layers (e.g., layer 1 812, layer 2 814, layer L 816) between the UE 1002 and a network entity (e.g., base station 1004). In some aspects, 1210 may be performed by the signal processing component 198.

At 1212, the UE may obtain a measurement result based on the set of RS. For example, referring to FIG. 10, the UE 1002 may obtain (e.g., at 1020 or 1022) a measurement result based on the set of RS. In some aspects, 1212 may be performed by the signal processing component 198.

At 1214, the UE may communicate with the network entity via the set of RS based on the measurement result. For example, referring to FIG. 10, the UE 1002 may, at 1024, communicate with the network entity (e.g., base station 1004) via the set of RS (e.g., at 1018) based on the measurement result (e.g., at 1020). In some aspects, 1214 may be performed by the signal processing component 198.

In some aspects, to obtain the measurement result (e.g., at 1212), the UE may measure the set of RS to generate the measurement result (e.g., at 1220) or receive an indication of the measurement result from the network entity (e.g., at 1222). For example, referring to FIG. 10, the UE 1002 may, at 1020, measure the set of RS to generate the measurement result, or, at 1022, receive an indication of the measurement result from the network entity (e.g., base station 1004) In some aspects, 1220 and 1222 may be performed by the signal processing component 198.

In some aspects, the first modulation order may be a first quadrature amplitude modulation (QAM) modulation order, and the second modulation order may be a second QAM modulation order. For example, referring to FIG. 10, the first modulation order for the set of reference signals (e.g., at 1018) may be a first QAM modulation order, and the second modulation order for a scheduled PDSCH or PUSCH on the UE 1002 may be a second QAM modulation order.

In some aspects, the set of RS may include one or more of: a first set of noise covariance reference signals, a second set of glue reference signals, or a third set of phase tracking reference signals (PTRS). For example, referring to FIG. 10, the set of RS (e.g., at 1018) may include one or more of: a first set of noise covariance reference signals (e.g., at 1040), a second set of glue reference signals (e.g., at 1042), or a third set of PTRS (e.g., at 1044).

In some aspects, the set of RS may be based on a modulation of one or more binary sequences into QAM modulation symbols. For example, referring to FIG. 8A, the set of RS (e.g., reference signals 822, 824, 826) may be based on a modulation of one or more binary sequences (e.g., binary sequence 802) into QAM modulation symbols (e.g., QAM modulation symbols 806).

In some aspects, the one or more binary sequences may be mapped into the QAM modulation symbols. For example, referring to FIG. 8A, the one or more binary sequences (e.g., binary sequence 802) may be mapped into the QAM modulation symbols (e.g., QAM modulation symbols 806). Referring to FIG. 8B, the one or more binary sequences (e.g., binary sequences 872, 874, 876) may be respectively mapped into the QAM modulation symbols (e.g., QAM modulation symbols 882, 884, 886).

In some aspects, at 1208, the UE may apply an orthogonal coverage code (OCC) on top of the set of RS. For example, referring to FIG. 10, the UE 1002 may, at 1016, apply an OCC on top of the set of RS. In some aspects, 1208 may be performed by the signal processing component 198.

In some aspects, the set of RS may include one of the second set of glue reference signals or the third set of PTRS, and the first number of signal streams may be equal to the second number of data layers between the UE and the network entity, and the first number of signal streams may be respectively mapped to the second number of data layers. For example, referring to FIG. 10, the set of RS (e.g., at 1018) may include one of the second set of glue reference signals (e.g., 1042) or the third set of PTRS (e.g., 1044). The first number of signal streams may be equal to the second number of data layers between the UE 1002 and the network entity (e.g., base station 1004). Referring to FIG. 8A, the first number of signal streams may be respectively mapped to the second number of data layers (e.g., layer 1 812, layer 2 814, layer L 816).

In some aspects, the set of RS may include the second set of glue reference signals, and the second set of glue reference signals may be located at a phase jump boundary region of resources of the PDSCH or the PUSCH. For example, referring to FIG. 9 and FIG. 10, the set of RS (e.g., at 1018) may include the second set of glue reference signals (e.g., 1042), and the second set of glue reference signals (e.g., glue reference signal 916, 926) may be located at a phase jump boundary region (e.g., phase jump boundary 902) of resources of the PDSCH or the PUSCH.

In some aspects, the PDSCH or the PUSCH may be scheduled for the UE, and each resource element (RE) for the set of RS may carry the second number of data layers of RS QAM symbols. For example, referring to FIG. 8A and FIG. 10, the PDSCH or the PUSCH may be scheduled for the UE 1002, and each RE for the set of RS (e.g., at 1018) may carry the second number of data layers of RS QAM symbols (e.g., QAM modulation symbols 806).

In some aspects, the second number of data layers of the RS QAM symbols may include the repetition of an RS QAM symbol for the second number of data layers. For example, referring to FIG. 8A, the second number of data layers (e.g., layer 1 812, layer 2 814, layer L 816) of the RS QAM symbols may include the repetition of an RS QAM symbol (e.g., QAM modulation symbols 806) for the second number (e.g., L) of data layers.

In some aspects, the UE may, at 1202, generate a seed sequence and, at 1206, generate the second number of data layers of the RS QAM symbols based on the seed sequence. For example, referring to FIG. 10, the UE 1002 may, at 1012, generate a seed sequence and, at 1014, generate the second number of data layers of the RS QAM symbols based on the seed sequence. Referring to FIG. 8A, the UE may generate a seed sequence (e.g., binary sequence 802) and generate the second number of data layers of the RS QAM symbols (e.g., QAM modulation symbols 806) based on the seed sequence (e.g., binary sequence 802). In some aspects, 1202 and 1206 may be performed by the signal processing component 198.

In some aspects, the set of RS may include the second set of glue reference signals, and the second set of glue reference signals may be different across a phase jump boundary region on resources of the PDSCH or the PUSCH. For example, referring to FIG. 10, the set of RS (e.g., at 1018) may include the second set of glue reference signals (e.g., 1042), and the second set of glue reference signals may be different across a phase jump boundary region (e.g., phase jump boundary 902) on resources of the PDSCH or the PUSCH.

In some aspects, each of the second number of data layers of the RS QAM symbols may be independent from each other. For example, referring to FIG. 8B, each of the second number of data layers (e.g., layer 1 852, layer 2 854, layer L 856) of the RS QAM symbols (e.g., QAM modulation symbols 882, 884, 886) may be independent from each other.

In some aspects, the UE may, at 1204, generate a first number of seed sequences and, at 1206, generate the second number of data layers of the RS QAM symbols respectively based on the first number of seed sequences. For example, referring to FIG. 8B, the UE may generate the second number of data layers (e.g., layer 1 852, layer 2 854, layer L 856) of the RS QAM symbols respectively based on the first number of seed sequences (e.g., binary sequences 872, 874, 876). In some aspects, 1204 may be performed by the signal processing component 198.

In some aspects, to generate the first number of seed sequences (e.g., at 1204), the UE may generate the first number of seed sequences based on a first number of seeds, and each of the first number of seeds is independent from each other. For example, referring to FIG. 8B, the UE may generate the first number of seed sequences (e.g., binary sequences 872, 874, 876) based on a first number of seeds (e.g., seed 871, 873, 875), and each of the first number of seeds (e.g., seed 871, 873, 875) may be independent from each other.

In some aspects, to generate the first number of seed sequences (e.g., at 1204), the UE may obtain the first number of seed sequences from a first binary sequence. The first length of the first binary sequence may be equal to at least the product (or multiplication) of a second length of the seed sequences and the first number. For example, referring to FIG. 8B, the UE may obtain the first number of seed sequences (e.g., binary sequences 872, 874, 876) from a first binary sequence (e.g., long sequence 860). The first length of the first binary sequence (e.g., long sequence 860) may be equal to at least the product (or multiplication) of a second length of the seed sequences (e.g., the length of binary sequence 872) and the first number (e.g., L).

In some aspects, the set of RS may include the second set of glue reference signals, and the second set of glue reference signals may remain consistent across a phase jump boundary region on resources of the PDSCH or the PUSCH. For example, referring to FIG. 9 and FIG. 10, the set of RS (e.g., at 1018) may include the second set of glue reference signals (e.g., 1042), and the second set of glue reference signals may remain consistent across a phase jump boundary region (e.g., phase jump boundary 902) on resources of the PDSCH or the PUSCH.

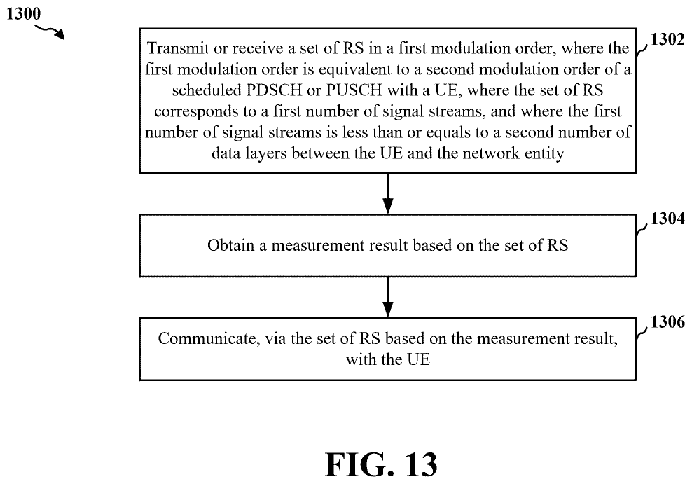

FIG. 13 is a flowchart 1300 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing reference signals (e.g., noise covariance RS or Rnn RS) in certain time domain resources (e.g., those without DMRS symbols), and ensuring that the RS is transmitted using the same modulation order as the scheduled downlink or uplink transmissions, the methods enable a receiver (e.g., UE) to more effectively capture and compensate for interference, including interference from thermal noise and cross-cell interference, thereby improving signal stability and reducing decoding errors in wireless communication. Additionally, by providing RS (e.g., glue RS) near phase jump boundaries and mapping these RS to corresponding data layers, the methods facilitate accurate phase correction even when DMRS is not available, thereby ensuring the reliability of wireless communication.

As shown in FIG. 13, at 1302, the network entity may transmit or receive a set of RS in a first modulation order. The first modulation order may be equivalent to a second modulation order of a scheduled PDSCH or PUSCH with a UE. The set of RS may correspond to a first number of signal streams, and the first number of signal streams may be less than or equal to a second number of data layers between the UE and the network entity. FIG. 8A, FIG. 8B, FIG. 9, and FIG. 10 illustrate various aspects of the steps in connection with flowchart 1300. For example, referring to FIG. 10, the network entity (e.g., base station 1004) may, at 1018, transmit to or receive from UE 1002 a set of RS in a first modulation order. The first modulation order may be equivalent to a second modulation order of a scheduled PDSCH or PUSCH with UE 1002. Referring to FIG. 8A, the set of RS (e.g., reference signals 822, 824, 826) may correspond to a first number of signal streams, and the first number of signal streams may be less than or equal to a second number (e.g., L) of data layers (e.g., layer 1 812, layer 2 814, layer L 816) between the UE 1002 and a network entity (e.g., base station 1004). In some aspects, 1302 may be performed by the signal processing component 199.

At 1304, the network entity may obtain a measurement result based on the set of RS. For example, referring to FIG. 10, the network entity (e.g., base station 1004) may, at 1036 or 1022, obtain a measurement result based on the set of RS. In some aspects, 1304 may be performed by the signal processing component 199.

In some aspects, at 1306, the network entity may communicate with the UE via the set of RS based on the measurement result. For example, referring to FIG. 10, the network entity (e.g., base station 1004) may, at 1024, communicate with the UE 1002 via the set of RS based on the measurement result. In some aspects, 1306 may be performed by the signal processing component 199.

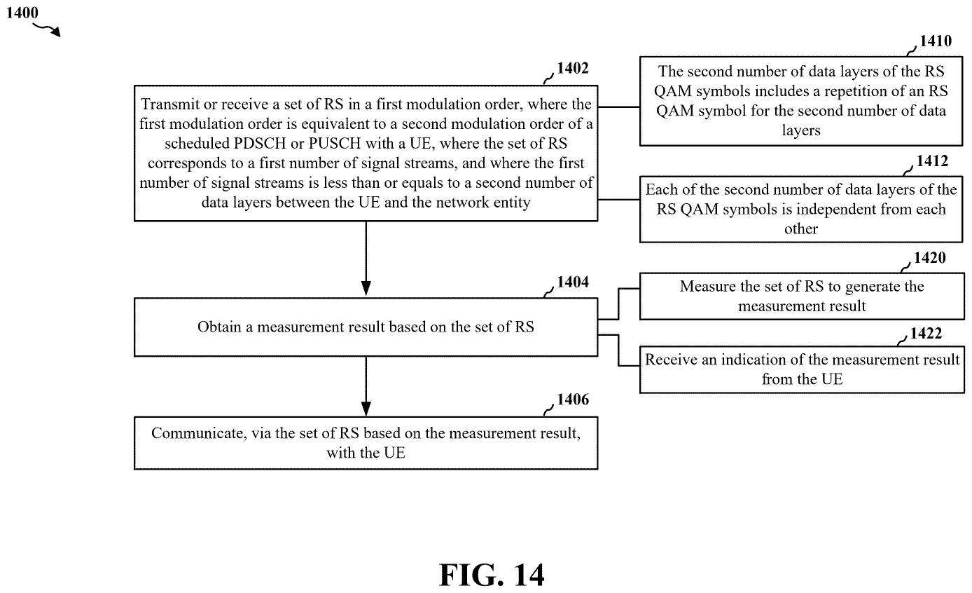

FIG. 14 is a flowchart 1400 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 1004; or the network entity 1502 in the hardware implementation of FIG. 15). The UE may be the UE 104, 350, 1002, or the apparatus 1504 in the hardware implementation of FIG. 15. By providing reference signals (e.g., noise covariance RS or Rnn RS) in certain time domain resources (e.g., those without DMRS symbols), and ensuring that the RS is transmitted using the same modulation order as the scheduled downlink or uplink transmissions, the methods enable a receiver (e.g., UE) to more effectively capture and compensate for interference, including interference from thermal noise and cross-cell interference, thereby improving signal stability and reducing decoding errors in wireless communication. Additionally, by providing RS (e.g., glue RS) near phase jump boundaries and mapping these RS to corresponding data layers, the methods facilitate accurate phase correction even when DMRS is not available, thereby ensuring the reliability of wireless communication.

As shown in FIG. 14, at 1402, the network entity may transmit or receive a set of RS in a first modulation order. The first modulation order may be equivalent to a second modulation order of a scheduled PDSCH or PUSCH with a UE. The set of RS may correspond to a first number of signal streams, and the first number of signal streams may be less than or equal to a second number of data layers between the UE and the network entity. FIG. 8A, FIG. 8B, FIG. 9, and FIG. 10 illustrate various aspects of the steps in connection with flowchart 1400. For example, referring to FIG. 10, the network entity (e.g., base station 1004) may, at 1018, transmit to or receive from UE 1002 a set of RS in a first modulation order. The first modulation order may be equivalent to a second modulation order of a scheduled PDSCH or PUSCH with UE 1002. Referring to FIG. 8A, the set of RS (e.g., reference signals 822, 824, 826) may correspond to a first number of signal streams, and the first number of signal streams may be less than or equal to a second number (e.g., L) of data layers (e.g., layer 1 812, layer 2 814, layer L 816) between the UE 1002 and a network entity (e.g., base station 1004). In some aspects, 1402 may be performed by the signal processing component 199.

At 1404, the network entity may obtain a measurement result based on the set of RS. For example, referring to FIG. 10, the network entity (e.g., base station 1004) may, at 1036 or 1022, obtain a measurement result based on the set of RS. In some aspects, 1404 may be performed by the signal processing component 199.

In some aspects, at 1406, the network entity may communicate with the UE via the set of RS based on the measurement result. For example, referring to FIG. 10, the network entity (e.g., base station 1004) may, at 1024, communicate with the UE 1002 via the set of RS based on the measurement result. In some aspects, 1406 may be performed by the signal processing component 199.

In some aspects, to obtain the measurement result (e.g., at 1404), the network entity may, at 1420, measure on the set of RS to generate the measurement result, or, at 1422, receive an indication the measurement result from the UE. For example, referring to FIG. 10, the network entity (e.g., base station 1004) may, at 1036, measure on the set of RS to generate the measurement result, or, at 1022, receive an indication the measurement result from the UE 1002. In some aspects, 1420 and 1422 may be performed by the signal processing component 199.

In some aspects, the first modulation order may be a first QAM modulation order, and the second modulation order may be a second QAM modulation order. For example, referring to FIG. 10, the first modulation order for the set of reference signals (e.g., at 1018) may be a first QAM modulation order, and the second modulation order for a scheduled PDSCH or PUSCH may be a second QAM modulation order.

In some aspects, the set of RS (e.g., at 1402) may include one or more of: a first set of noise covariance reference signals, a second set of glue reference signals, or a third set of PTRS. For example, referring to FIG. 10, the set of RS (e.g., at 1018) may include one or more of: a first set of noise covariance reference signals (e.g., at 1040), a second set of glue reference signals (e.g., at 1042), or a third set of PTRS (e.g., at 1044).

In some aspects, the set of RS may be based on a modulation of one or more binary sequences into QAM modulation symbols. For example, referring to FIG. 8A, the set of RS (e.g., reference signals 822, 824, 826) may be based on a modulation of one or more binary sequences (e.g., binary sequence 802) into QAM modulation symbols (e.g., QAM modulation symbols 806).

In some aspects, the one or more binary sequences may be mapped into the QAM modulation symbols. For example, referring to FIG. 8A, the one or more binary sequences (e.g., binary sequence 802) may be mapped into the QAM modulation symbols (e.g., QAM modulation symbols 806). Referring to FIG. 8B, the one or more binary sequences (e.g., binary sequences 872, 874, 876) may be respectively mapped into the QAM modulation symbols (e.g., QAM modulation symbols 882, 884, 886).

In some aspects, the set of RS may include one of the second set of glue reference signals or the third set of PTRS, and the first number of signal streams may be equal to the second number of data layers between the UE and the network entity, and the first number of signal streams may be respectively mapped to the second number of data layers. For example, referring to FIG. 10, the set of RS (e.g., at 1018) may include one of the second set of glue reference signals (e.g., 1042) or the third set of PTRS (e.g., 1044). The first number of signal streams may be equal to the second number of data layers between the UE 1002 and the network entity (e.g., base station 1004). Referring to FIG. 8A, the first number of signal streams may be respectively mapped to the second number of data layers (e.g., layer 1 812, layer 2 814, layer L 816).

In some aspects, the PDSCH or the PUSCH is scheduled for the UE, and each RE for the set of RS may carry the second number of data layers of RS QAM symbols. For example, referring to FIG. 8A and FIG. 10, the PDSCH or the PUSCH may be scheduled for the UE 1002, and each RE for the set of RS (e.g., at 1018) may carry the second number of data layers of RS QAM symbols (e.g., QAM modulation symbols 806).

In some aspects, at 1410, the second number of data layers of the RS QAM symbols may include the repetition of an RS QAM symbol for the second number of data layers. For example, referring to FIG. 8A, the second number of data layers (e.g., layer 1 812, layer 2 814, layer L 816) of the RS QAM symbols may include the repetition of an RS QAM symbol (e.g., QAM modulation symbols 806) for the second number (e.g., L) of data layers.

In some aspects, at 1412, each of the second number of data layers of the RS QAM symbols may be independent from each other. For example, referring to FIG. 8B, each of the second number of data layers (e.g., layer 1 852, layer 2 854, layer L 856) of the RS QAM symbols (e.g., QAM modulation symbols 882, 884, 886) may be independent from each other.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to transmit or receive a set of RS in a first modulation order, where the first modulation order is equivalent to a second modulation order of a scheduled PDSCH or PUSCH on the UE, where the set of RS corresponds to a first number of signal streams, and where the first number of signal streams is less than or equal to a second number of data layers between the UE and a network entity; obtain a measurement result based on the set of RS; and communicate with the network entity via the set of RS based on the measurement result. The component 198 may be further configured to perform any of the aspects described in connection with the flowcharts in FIG. 11 and FIG. 12, and/or performed by the UE 1002 in FIG. 10. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for transmitting or receiving a set of RS in a first modulation order, where the first modulation order is equivalent to a second modulation order of a scheduled PDSCH or PUSCH on the UE, where the set of RS corresponds to a first number of signal streams, and where the first number of signal streams is less than or equal to a second number of data layers between the UE and a network entity, means for obtaining a measurement result based on the set of RS, and means for communicating with the network entity via the set of RS based on the measurement result. The apparatus 1504 may further include means for performing any of the aspects described in connection with the flowcharts in FIG. 11 and FIG. 12, and/or aspects performed by the UE 1002 in FIG. 10. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

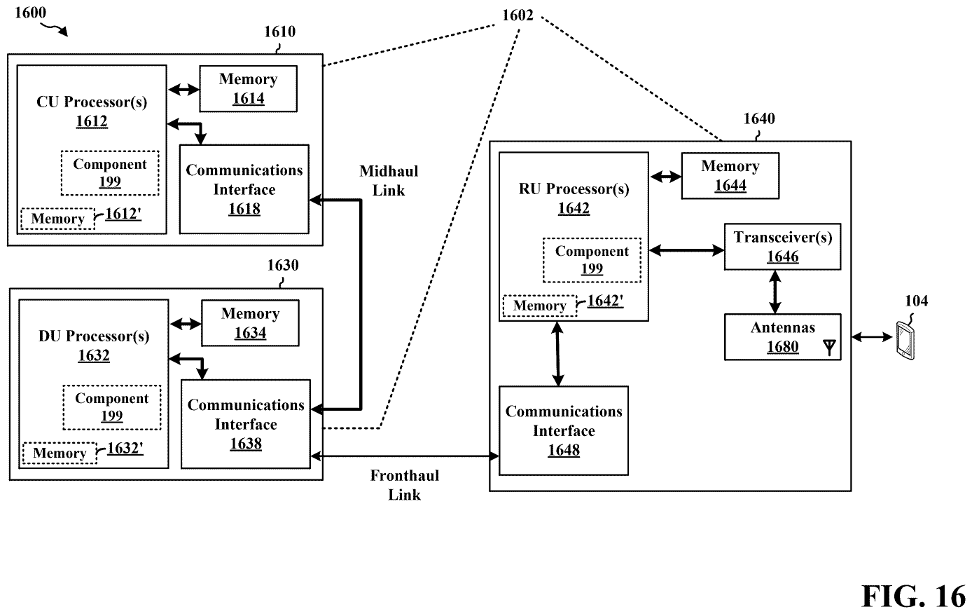

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit or receive a set of RS in a first modulation order, where the first modulation order is equivalent to a second modulation order of a scheduled PDSCH or PUSCH with a UE, where the set of RS corresponds to a first number of signal streams, and where the first number of signal streams is less than or equals to a second number of data layers between the UE and the network entity; obtain a measurement result based on the set of RS; and communicate with the UE via the set of RS based on the measurement result. The component 199 may be further configured to perform any of the aspects described in connection with the flowcharts in FIG. 13 and FIG. 14, and/or performed by the base station 1004 in FIG. 10. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for transmitting or receiving a set of RS in a first modulation order, where the first modulation order is equivalent to a second modulation order of a scheduled PDSCH or PUSCH with a UE, where the set of RS corresponds to a first number of signal streams, and where the first number of signal streams is less than or equals to a second number of data layers between the UE and the network entity, means for obtaining a measurement result based on the set of RS, and means for communicating with the UE via the set of RS based on the measurement result. The network entity 1602 may further include means for performing any of the aspects described in connection with the flowcharts in FIG. 13 and FIG. 14, and/or aspects performed by the base station 1004 in FIG. 10. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include transmitting or receiving a set of RS in a first modulation order, where the first modulation order is equivalent to a second modulation order of a scheduled PDSCH or PUSCH on the UE, where the set of RS corresponds to a first number of signal streams, and where the first number of signal streams is less than or equal to a second number of data layers between the UE and a network entity; obtaining a measurement result based on the set of RS; and communicating with the network entity via the set of RS based on the measurement result. By providing reference signals (e.g., noise covariance RS or Rnn RS) in certain time domain resources (e.g., those without DMRS symbols), and ensuring that the RS is transmitted using the same modulation order as the scheduled downlink or uplink transmissions, the methods enable a receiver (e.g., UE) to more effectively capture and compensate for interference, including interference from thermal noise and cross-cell interference, thereby improving signal stability and reducing decoding errors in wireless communication. Additionally, by providing RS (e.g., glue RS) near phase jump boundaries and mapping these RS to corresponding data layers, the methods facilitate accurate phase correction even when DMRS is not available, thereby ensuring the reliability of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes transmitting or receiving a set of reference signals (RS) in a first modulation order, wherein the first modulation order is equivalent to a second modulation order of a scheduled physical downlink shared channel (PDSCH) or physical uplink shared channel (PUSCH) on the UE, wherein the set of RS corresponds to a first number of signal streams, and wherein the first number of signal streams is less than or equal to a second number of data layers between the UE and a network entity; obtaining a measurement result based on the set of RS; and communicating, via the set of RS based on the measurement result, with the network entity.

Aspect 2 is the method of aspect 1, wherein obtaining the measurement result includes measuring the set of RS to generate the measurement result, or receiving, from the network entity, an indication of the measurement result.

Aspect 3 is the method of any of aspects 1 to 2, wherein the first modulation order is a first quadrature amplitude modulation (QAM) modulation order, and the second modulation order is a second QAM modulation order.

Aspect 4 is the method of any of aspects 1 to 3, wherein the set of RS includes one or more of: a first set of noise covariance reference signals, a second set of glue reference signals, or a third set of phase tracking reference signals (PTRS).

Aspect 5 is the method of any of aspects 1 to 4, wherein the set of RS is based on a modulation of one or more binary sequences into QAM modulation symbols.

Aspect 6 is the method of aspect 5, wherein the one or more binary sequences are mapped into the QAM modulation symbols.

Aspect 7 is the method of aspect 5, where the method further includes applying an orthogonal coverage code (OCC) on top of the set of RS.

Aspect 8 is the method of aspect 4, wherein the set of RS includes one of the second set of glue reference signals or the third set of PTRS, wherein the first number of signal streams is equal to the second number of data layers between the UE and the network entity, and wherein the first number of signal streams is respectively mapped to the second number of data layers.

Aspect 9 is the method of aspect 8, wherein the set of RS includes the second set of glue reference signals, and wherein the second set of glue reference signals is located at a phase jump boundary region of resources of the PDSCH or the PUSCH.

Aspect 10 is the method of aspect 8, wherein the PDSCH or the PUSCH is scheduled for the UE, and wherein each resource element (RE) for the set of RS carries the second number of data layers of RS QAM symbols.

Aspect 11 is the method of aspect 10, wherein the second number of data layers of the RS QAM symbols includes a repetition of an RS QAM symbol for the second number of data layers.

Aspect 12 is the method of aspect 10, where the method further includes generating a seed sequence; and generating the second number of data layers of the RS QAM symbols based on the seed sequence.

Aspect 13 is the method of aspect 11, wherein the set of RS includes the second set of glue reference signals, and wherein the second set of glue reference signals is different across a phase jump boundary region on resources of the PDSCH or the PUSCH.

Aspect 14 is the method of aspect 10, wherein each of the second number of data layers of the RS QAM symbols is independent from each other.

Aspect 15 is the method of aspect 14, where the method further includes generating a first number of seed sequences; and generating the second number of data layers of the RS QAM symbols respectively based on the first number of seed sequences.

Aspect 16 is the method of aspect 15, wherein generating the first number of seed sequences includes generating the first number of seed sequences based on a first number of seeds, wherein each of the first number of seeds is independent from each other.

Aspect 17 is the method of aspect 15, wherein generating the first number of seed sequences includes obtaining the first number of seed sequences from a first binary sequence, wherein a first length of the first binary sequence is equal to at least product of a second length of the seed sequences and the first number.

Aspect 18 is the method of aspect 14, wherein the set of RS includes the second set of glue reference signals, wherein the second set of glue reference signals remains consistent across a phase jump boundary region on resources of the PDSCH or the PUSCH.

Aspect 19 is an apparatus for wireless communication at a UE, comprising: at least one memory; and at least one processor coupled to the at least one memory, the at least one processor is configured to perform the method of any of aspects 1 to 18.

Aspect 20 is the apparatus for wireless communication at a UE, comprising means for performing each step in the method of any of aspects 1-18.

Aspect 21 is an apparatus of any of aspects 19-20, further comprising a transceiver configured to receive or to transmit in association with the method of any of aspects 1-18.

Aspect 22 is a computer-readable medium (e.g., a non-transitory computer-readable medium) storing computer executable code at a UE, the code when executed by at least one processor causes the at least one processor to perform the method of any of aspects 1-18.

Aspect 23 is a method of wireless communication at a network entity. The method includes transmitting or receiving a set of reference signals (RS) in a first modulation order, wherein the first modulation order is equivalent to a second modulation order of a scheduled physical downlink shared channel (PDSCH) or physical uplink shared channel (PUSCH) with a user equipment (UE), wherein the set of RS corresponds to a first number of signal streams, and wherein the first number of signal streams is less than or equals to a second number of data layers between the UE and the network entity; obtaining a measurement result based on the set of RS; and communicating, via the set of RS based on the measurement result, with the UE.

Aspect 24 is the method of aspect 23, wherein obtaining the measurement result includes measuring on the set of RS to generate the measurement result, or receiving, from the UE, an indication the measurement result.

Aspect 25 is the method of any of aspects 23 to 24, wherein the first modulation order is a first quadrature amplitude modulation (QAM) modulation order, and the second modulation order is a second QAM modulation order.

Aspect 26 is the method of any of aspects 23 to 25, wherein the set of RS includes one or more of: a first set of noise covariance reference signals, a second set of glue reference signals, or a third set of phase tracking reference signals (PTRS).

Aspect 27 is the method of aspect 26, wherein the set of RS is based on a modulation of one or more binary sequences into QAM modulation symbols.

Aspect 28 is the method of aspect 27, wherein the one or more binary sequences are mapped into the QAM modulation symbols.

Aspect 29 is the method of aspect 26, wherein the set of RS includes one of the second set of glue reference signals or the third set of PTRS, wherein the first number of signal streams is equal to the second number of data layers between the UE and the network entity, and wherein the first number of signal streams is respectively mapped to the second number of data layers.

Aspect 30 is the method of aspect 29, wherein the PDSCH or the PUSCH is scheduled for the UE, and wherein each resource element (RE) for the set of RS carries the second number of data layers of RS QAM symbols.

Aspect 31 is the method of aspect 30, wherein the second number of data layers of the RS QAM symbols includes a repetition of an RS QAM symbol for the second number of data layers.

Aspect 32 is the method of aspect 30, wherein each of the second number of data layers of the RS QAM symbols is independent from each other.

Aspect 33 is an apparatus for wireless communication at a network entity, comprising: at least one memory; and at least one processor coupled to the at least one memory and, where the at least one processor is configured to perform the method of any of aspects 23-32.

Aspect 34 is the apparatus for wireless communication at a network entity, comprising means for performing each step in the method of any of aspects 23-32.

Aspect 35 is an apparatus of any of aspects 33-34, further comprising a transceiver configured to receive or to transmit in association with the method of any of aspects 23-32.

Aspect 36 is a computer-readable medium (e.g., a non-transitory computer-readable medium) storing computer executable code at a network entity, the code when executed by at least one processor causes the at least one processor to perform the method of any of aspects 23-32.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
transmit or receive a set of reference signals (RS) in a first modulation order, wherein the first modulation order is equivalent to a second modulation order of a scheduled physical downlink shared channel (PDSCH) or physical uplink shared channel (PUSCH) on the UE, wherein the set of RS corresponds to a first number of signal streams, and wherein the first number of signal streams is less than or equal to a second number of data layers between the UE and a network entity;
obtain a measurement result based on the set of RS; and
communicate, via the set of RS based on the measurement result, with the network entity.

2. The apparatus of claim 1, further comprising a transceiver coupled to the at least one processor, wherein to transmit or receive the set of RS, the at least one processor is configured to transmit or receive the set of RS via the transceiver, wherein to obtain the measurement result, the at least one processor is configured to:
measure the set of RS to generate the measurement result, or
receive, from the network entity, an indication of the measurement result.

3. The apparatus of claim 2, wherein the first modulation order is a first quadrature amplitude modulation (QAM) modulation order, and the second modulation order is a second QAM modulation order.

4. The apparatus of claim 3, wherein the set of RS includes one or more of:
a first set of noise covariance reference signals,
a second set of glue reference signals, or
a third set of phase tracking reference signals (PTRS).

5. The apparatus of claim 4, wherein the set of RS is based on a modulation of one or more binary sequences into QAM modulation symbols.

6. The apparatus of claim 5, wherein the one or more binary sequences are mapped into the QAM modulation symbols.

7. The apparatus of claim 5, wherein the at least one processor is further configured to:
apply an orthogonal coverage code (OCC) on top of the set of RS.

8. The apparatus of claim 4, wherein the set of RS includes one of the second set of glue reference signals or the third set of PTRS, wherein the first number of signal streams is equal to the second number of data layers between the UE and the network entity, and wherein the first number of signal streams is respectively mapped to the second number of data layers.

9. The apparatus of claim 8, wherein the set of RS includes the second set of glue reference signals, and wherein the second set of glue reference signals is located at a phase jump boundary region of resources of the PDSCH or the PUSCH.

10. The apparatus of claim 8, wherein the PDSCH or the PUSCH is scheduled for the UE, and wherein each resource element (RE) for the set of RS carries the second number of data layers of RS QAM symbols.

11. The apparatus of claim 10, wherein the second number of data layers of the RS QAM symbols includes a repetition of an RS QAM symbol for the second number of data layers.

12. The apparatus of claim 10, wherein the at least one processor is further configured to:
generate a seed sequence; and
generate the second number of data layers of the RS QAM symbols based on the seed sequence.

13. The apparatus of claim 11, wherein the set of RS includes the second set of glue reference signals, and wherein the second set of glue reference signals is different across a phase jump boundary region on resources of the PDSCH or the PUSCH.

14. The apparatus of claim 10, wherein each of the second number of data layers of the RS QAM symbols is independent from each other.

15. The apparatus of claim 14, wherein the at least one processor is further configured to:
generate a first number of seed sequences; and
generate the second number of data layers of the RS QAM symbols respectively based on the first number of seed sequences.

16. The apparatus of claim 15, wherein to generate the first number of seed sequences, the at least one processor is configured to:
generate the first number of seed sequences based on a first number of seeds, wherein each of the first number of seeds is independent from each other.

17. The apparatus of claim 15, wherein to generate the first number of seed sequences, the at least one processor is configured to:
obtain the first number of seed sequences from a first binary sequence, wherein a first length of the first binary sequence is equal to at least product of a second length of the seed sequences and the first number.

18. The apparatus of claim 14, wherein the set of RS includes the second set of glue reference signals, wherein the second set of glue reference signals remains consistent across a phase jump boundary region on resources of the PDSCH or the PUSCH.

19. An apparatus for wireless communication at a network entity, comprising:
at least one memory; and
at least one processor coupled to the at least one memory and, based at least in part on information stored in the at least one memory, the at least one processor is configured to:
transmit or receive a set of reference signals (RS) in a first modulation order, wherein the first modulation order is equivalent to a second modulation order of a scheduled physical downlink shared channel (PDSCH) or physical uplink shared channel (PUSCH) with a user equipment (UE), wherein the set of RS corresponds to a first number of signal streams, and wherein the first number of signal streams is less than or equals to a second number of data layers between the UE and the network entity;
obtain a measurement result based on the set of RS; and
communicate, via the set of RS based on the measurement result, with the UE.

20. The apparatus of claim 19, further comprising a transceiver coupled to the at least one processor, wherein to transmit or receive the set of RS, the at least one processor is configured to transmit or receive the set of RS via the transceiver, wherein to obtain the measurement result, the at least one processor is configured to:
measure on the set of RS to generate the measurement result, or
receive, from the UE, an indication the measurement result.

21. The apparatus of claim 20, wherein the first modulation order is a first quadrature amplitude modulation (QAM) modulation order, and the second modulation order is a second QAM modulation order.

22. The apparatus of claim 21, wherein the set of RS includes one or more of:
a first set of noise covariance reference signals,
a second set of glue reference signals, or
a third set of phase tracking reference signals (PTRS).

23. The apparatus of claim 22, wherein the set of RS is based on a modulation of one or more binary sequences into QAM modulation symbols.

24. The apparatus of claim 23, wherein the one or more binary sequences are mapped into the QAM modulation symbols.

25. The apparatus of claim 22, wherein the set of RS includes one of the second set of glue reference signals or the third set of PTRS, wherein the first number of signal streams is equal to the second number of data layers between the UE and the network entity, and wherein the first number of signal streams is respectively mapped to the second number of data layers.

26. The apparatus of claim 25, wherein the PDSCH or the PUSCH is scheduled for the UE, and wherein each resource element (RE) for the set of RS carries the second number of data layers of RS QAM symbols.

27. The apparatus of claim 26, wherein the second number of data layers of the RS QAM symbols includes a repetition of an RS QAM symbol for the second number of data layers.

28. The apparatus of claim 26, wherein each of the second number of data layers of the RS QAM symbols is independent from each other.

29. A method of wireless communication at a user equipment (UE), comprising:
transmitting or receiving a set of reference signals (RS) in a first modulation order, wherein the first modulation order is equivalent to a second modulation order of a scheduled physical downlink shared channel (PDSCH) or physical uplink shared channel (PUSCH) on the UE, wherein the set of RS corresponds to a first number of signal streams, and wherein the first number of signal streams is less than or equal to a second number of data layers between the UE and a network entity;
obtaining a measurement result based on the set of RS; and
communicating, via the set of RS based on the measurement result, with the network entity.

30. A method of wireless communication at a network entity, comprising:
transmitting or receiving a set of reference signals (RS) in a first modulation order, wherein the first modulation order is equivalent to a second modulation order of a scheduled physical downlink shared channel (PDSCH) or physical uplink shared channel (PUSCH) with a user equipment (UE), wherein the set of RS corresponds to a first number of signal streams, and wherein the first number of signal streams is less than or equals to a second number of data layers between the UE and the network entity;
obtaining a measurement result based on the set of RS; and
communicating, via the set of RS based on the measurement result, with the UE.
